(19) United States
(12) Patent Application Publication
(10) Pub. No.: US 2014/0280753 A1
(43) Pub. Date: Sep. 18, 2014

(54) METHOD AND APPARATUS FOR PEER-TO-PEER FILE SHARING

(71) Applicant: ARROWARE INDUSTRIES, INC., Ohsweken (CA)

(72) Inventors: Phillip James Kinsman, Hamilton (CA); Harvey Christopher Howard Medcalf, Ancaster (CA)

(73) Assignee: ARROWARE INDUSTRIES, INC., Ohsweken (CA)

(21) Appl. No.: 13/837,943

(22) Filed: Mar. 15, 2013

(51) Int. Cl. H04L 29/08

(52) U.S. Cl. CPC H04L 67/104
USPC 709/219

(57) ABSTRACT

Peer-to-peer sharing of information is described. A requester peer device obtains portions of a desired digital content from a select number of provider peer devices. The provider peer devices are selected using statistical information that considers historical data access between the requester communication peer device and the provider communication peer devices. The requester peer device also obtains an amount of error correcting data associated with the requested portions of the digital content from the server. The amount of error correcting data is determined using the statistical information. The requester peer device reconstructs the desired digital content using a combination of the digital content portions obtained from the selected provider peers and the error correcting data obtained from the server.

### FIELD OF INVENTION

The present invention generally relates to peer-to-peer sharing of digital content among peer communication devices disposed in a communication system.

### BACKGROUND

A typical peer-to-peer (P2P) network relies on the computing power and bandwidth of its participating peers rather than solely relying on a server to handle file distribution among the peers. In such systems, each peer in the network is, typically, allowed to directly share individual files with other peers and assist the server in distributing individual files among the peers. The server often holds a centralized list of files maintained by the peers and, upon being prompted by a peer for a particular file, consults the centralized list, determines a select number of peers known to have all or parts of that particular file, and instructs the peer to establish direct connection with the select number peers to obtain the file. Once the peer has downloaded that particular file, it can serve as a peer that provides the file to other peers in the network.

Although such P2P systems, by distributing the tasks of uploading and downloading portions of a file among the peers, relieve the server from the burden of handling such file requests, they can encounter problems when very few peers have a complete copy of a desired file. Specifically, when peers that have a certain portion of a file that is not available by other peers become unavailable, a peer requesting the file would need to wait indefinitely for all portions of the file to become available in order for downloading to be completed.

### SUMMARY

A method, computerized system, and computer program product according to some embodiments disclosed herein relates to peer-to-peer sharing of information among communication peer devices disposed in a multi-node communication network having a plurality of communication peer devices managed by a server. A requester communication peer device obtains information identifying communication peer devices storing at least one portion of a select digital content. The requester communication peer device selects a set of the communication peer devices based on statistical information representing historical data access between the requester communication peer device and the selected set of communication peer devices and requests individual portions of the digital content from the selected set of communication peer devices. The digital content can be reconstructed from the individual portions received from the selected set of communication peer devices.

In other examples, any of the aspects above, or any system, method, apparatus, and computer program product method described herein, can include one or more of the following features.

In some embodiments, the requester communication peer device can request an amount of reconstruction data, associated with the requested portions of the digital content, from the server. The amount of requested reconstruction data can be dependent on the statistical information.

In certain embodiments, the requester communication peer device can determine whether the individual portions of digital content are received within a predetermined time window; and in an event at least one portion of the digital content is not received within the predetermined time window, reconstruct the digital content using a combination of individual portions received from the selected set of communication peer devices and the reconstruction data received from the server. In some embodiments, the requester communication peer device can determine whether the individual portions of digital content are received within a predetermined time window; and in an event all portions of the digital content is received within the predetermined time window, reconstruct the digital content solely based on the individual portions received from the selected set of communication peer devices.

In some embodiments, the requester communication peer device can select the select digital content through a user interface provided by the requester peer device and receive information identifying the selected set of communication peer devices, each storing at least one individual portion of the requested digital content, from the server. In some embodiments, the user of the requester peer device can be associated with a social network system or website or other secure systems.

In certain embodiments, the requester communication peer device can determine a number of individual portions of digital content to request from each of the communication peer devices based on the statistical information. In some embodiments, the statistical information representing historical data access can include historical data transfer rates between the requester communication peer device and each communication peer device of the selected set. In certain embodiments, the statistical information representing historical data access can include at least one of time to first byte arrival, data integrity, routability, or a combination thereof. In some embodiments, the statistical information representing historical data access can include status information of previous content transfer requests among the communication peer devices, the status information including occurrences of at least one of acceptance of the previous content transfer requests, denial of the previous content transfer requests, and suspension of the previous content transfer requests before content transfer is completed.

In some embodiments, the requester communication peer device can determine an order for requesting the individual portions of digital content from each of the communication peer devices in the selected set based on statistical information representing historical access patterns of the digital content.

In certain embodiments, the requester communication peer device can select the set of communication peer devices by communicating with each of the communication peer devices and determining which of the individual portions of the select digital content is stored at each device included in the selected set.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A is a block diagram of a peer-to-peer communication network, according to an illustrative embodiment disclosed herein.

FIG. 1B is a block diagram of a data content file that can be exchanged between the peer communication devices according to an embodiment disclosed herein.

FIG. 2 is an example illustration of digital electronic circuitry or computer hardware that can be used with the embodiments disclosed herein.

FIG. 3 is a flow diagram of procedures for viewing a digital content by a requester peer device according to embodiments disclosed herein.

FIG. 4 is a block diagram of procedures for loading a block of data according to an example embodiment disclosed herein.

FIG. 5 is a graphical representation of a Block Provision Profile (BPP) according to an embodiment disclosed herein.

### DETAILED DESCRIPTION

FIG. 1A is a block diagram of a peer-to-peer (P2P) communication system 100 according to an illustrative embodiment disclosed herein. The P2P communication system 100 includes a server 102 that is coupled, via a communication network 110, with a number of peer communication devices 120, 130. The peer devices 120, 130 are interconnected and are in communication with one another. The peer devices 120, 130 can be directly connected to one another, via a number of direct links 105, or connect to one another through the communication network 110.

The network 110 can be a private network (e.g., local area network (LAN)), a metropolitan area network (MAN), a wide area network (WAN), or a public network (e.g., the Internet). The communication network 110 can be a hybrid communication network 110 that includes all or parts of other networks. The networks 110 can various topologies (e.g., bus, star, or ring network topologies).

The peer devices 120, 130 are communication devices that are capable of establishing a connection to the communication network 110 and/or other peers 120, 130. Examples of the peer devices 120, 130 that can be used with the embodiments disclosed herein include, but are not limited to, workstations, wireless phones, smart phones, personal digital assistants, desktop computers, laptop computers, tablet computers, handheld computers, etc.

The peer devices 120, 130 connect to one another and the network 110 via a number of links 105. Depending on the type of the peer device 120, 130 used (e.g., wired or wireless device), the links 105 can be wired or wireless links.

The server 102 can be any computing device designated to run one or more services or function as a host. The server 102 can be any type of server and offer a wide range of services. For example, the server 102 can be a web server, database server, file server, mail server, gaming server, etc. In some embodiments, the server 102 can include a database 115. In some embodiments, the server 102 can allow the peer devices 120, 130 to store digital content on the server. For example, in certain embodiments, each peer device 120, 130 can have an allocated amount of storage on the server 102 that can be used by the peer device 120, 130 for content storage. In some embodiments, the server 102 can store files designated, by the peer device 120, 130, as having high priority in the database 115.

The server 102 can further maintain, in its database 115, some information regarding digital content that each peer device 120, 130 maintains and is willing to share with other peers. For example, in one embodiment, the server 102 can maintain a listing of all of the files that a peer device 120, 130 has obtained from other peer devices 120, 130 (e.g., through peer-to-peer download) and has indicated that it is willing to share. In some embodiments, the server 102 can store, in its database 115, a list of all peer devices 120, 130 that have, at some point, attempted to obtain at least a portion of a digital file. In certain embodiments, the server 102 can maintain a listing of the peers 120, 130 that have complete copies of a file. In some embodiments, the server 102 can maintain information regarding each portion of digital content that is stored on the peer devices 120, 130.

In some embodiments, the server 102 can maintain information that can be used to identify each peer device 120, 130. For example, in some embodiments, the server 102 can maintain information (e.g., login and password information) that can be used to uniquely identify and/or authenticate a peer device user. In some embodiments, the server 102 can maintain information (e.g., IP addresses) that can be used to uniquely identify a peer device. 120, 130. In some embodiments, the server 102 can maintain information indicating file access permissions for each peer device 120. For example, the server 102 can store information indicating which peer devices 120, 130 have the authorization to access a certain file.

In some embodiments, the peer devices 120, 130 can include a file sharing manager 140. In some embodiments, the file sharing manager 140 can be presented to a user (not shown) of the peer device 120, 130 using a user interface (not shown), such as a graphical user interface. In some embodiments, the file sharing manager 140 can be presented to the user using application software that provides an interactive medium for receiving input from the user. In certain embodiments, the file sharing manager 140 can be a web-based platform. In some embodiments, each peer device 120, 130 can access the file manager through the interactive medium provided by the application software or using the web-based interface.

The file sharing manager 140 can be used for digital content sharing (also referenced herein as file sharing) among the peer devices 120, 130. For example, a requester peer device 120 can utilize the file sharing manager 140 to request a digital content. In some embodiments, a requester peer device 130 can request the desired digital content by selecting from a list of files maintained by its peer devices 120. In certain embodiments, the requester peer device 120 can select the desired digital content by searching, using a search field (not shown) provided by the user interface of the file sharing manager 140. For example, the user of the requester peer 120 can enter appropriate search terms or key words in the search field to search for the desired digital content.

In some embodiments, upon selection of the desired digital content by the requester peer device 120, information regarding the selected digital content is forwarded to the server 102. In some embodiments, the requester peer device 120 can use a unique file identifier to represent the requested file. For example, in some embodiments, each file can be represented by a unique 10-byte sequence file identifier code. In some embodiments, when submitting a request for a digital content file, the requester peer 120 uses the unique identifier assigned to that file to request the file from the server.

The server 102, upon receiving the information about the desired digital content, consults the file listings stored in its database 115 to determine the peer devices 130 (hereinafter provider peer devices) that are known to have at least a portion of the digital content and/or are known to have, at some point, attempted to obtain a portion of the digital content. The listing of proposed provider peer devices 130 is forwarded to the requester peer device 120 for use in obtaining the digital content.

In some embodiments, the file sharing manager 140 of the requester peer device 120 can specify a maximum number of provider peer devices 120 that it wishes the server 102 to include in the listing of the proposed provider peer devices 130. For example, in one embodiment, the requester peer 120 can request that the server includes no more than fifty provider peers 130 in the listing of the proposed provider peer devices 130. The server 102 can select the provider peers 130 included in the listing by considering various factors. For example, in one embodiment, the server may select the provider peers 130 based on how frequently and how recently they have been in communication with the server.

In certain embodiments, in addition to providing the requester peer device 120 with a listing of possible provider peer devices 130, the server 102 can further forward information identifying the portions of the digital content that are maintained at each provider peer device 130. For example, the server 102 can indicate to the requester peer device 120 that a certain provider peer device 130 is known to have a complete copy of the desired digital content and/or another provider peer device 130 is known to a specific portion of the desired digital content.

FIG. 1B is a block diagram of a data content file 191 that can be exchanged between the peer communication devices. As shown, the data content file 191 can include multiple blocks 192. Each block can include a number of portions. For example, when sharing a video file, the video file can have multiple blocks, each of which can contain a certain segment of the video file. The blocks can be of the same size or can have different sizes. For example, in a video of a baseball game, the blocks can be arranged such that they include various portions of the game (e.g., a home run, the bottom of the 9^{th} inning, etc.). The portions 193 of each block 192 represent the different data portions, one or more of which can be requested from the provider peers 130 and used to reconstruct that block 192 of data.

The file sharing manager 140 of the requester peer device 120 employs the provider peer listing, obtained from the server 102, to select a number of provider peers from which the digital content is obtained. In some embodiments, the file sharing manager 140 can forward the peer listing to a peer selector 150 of the requester peer 120. The peer selector 150 consults a database 160 that includes certain statistical and/or historical information regarding the provider peer devices 130 to determine a select number of provider peers from which the digital content is obtained. In some embodiments, a requester peer 120 can use the peer performance model for selecting a provider peer 130. The peer performance model tracks prior transaction history between the provider peer 120 and the requester peer 130 and can be used to determine the optimal provider peer 130 for requesting the digital content.

In some embodiments, historical transfer rates of the provider peers 130 can be considered by the peer selector 150 of the requester peer 120 in determining a provider peer 130 for requesting the digital content. For example, if the requester peer 120 has historically connected to the provider peer 130 with a particularly low/high speed connection, the communication speed of the provider peer 130 can be considered by the peer selector 150 of the requester peer 120 in deciding whether to select that provider peer 130 for obtaining the digital content. In some embodiments, the peer selector 150 of the requester peer 120 can further consider historical connectivity features of the provider peers 130 to determine if that peer 130 should be selected for requesting data. For example, for provider peers 130 using a capped monthly data plan and having the tendency for being a more suitable provider peer in the beginning of a month as opposed to the end of the month, this behavior can be tracked by the peer selector 150 and considered in making provider peer selection.

In some embodiments, the statistical information can include other factors, such as time to first byte arrival, data integrity, or a combination thereof. In certain embodiments, the statistical information can include status information of previous content transfer requests among the communication peer devices. Specifically, the status information can include occurrences of events including the acceptance rates of the previous content transfer requests, the denial rates of the previous content transfer requests, and suspension rates of the previous content transfer requests before content transfer is completed. For example, the peer selector 150 of the requester peer device 120 can consider factors including the number of times that the requester peer device 120 has authorized another peer device 130 to obtain digital content from it, the number of times a provider peer device 130 has accepted or rejected requests initiated by the requester peer device 130, or a combination thereof.

In some embodiments, a requester peer 120 can use the peer performance model for selecting a provider peer 130. As noted, the peer performance model tracks prior transaction history between the provider peer 120 and the requester peer 130 and can be used to determine the optimal provider peer 130 for requesting the digital content. The transaction history tracked by the peer performance model can include factors such as the number of times a provider peer 130 has granted digital data requests initiated from the requester peer 120 and the number of times the requester peer 120 has granted digital data requests initiated from the provider peer 130. Using the peer performance model, the requester peer 120 can select a provider peer 130 for requesting portions of the digital content using a qualifying process that discards peers with very low probability of successfully transmitting the digital content along with peers having low provider incentive (e.g., peers historically known to deny digital data sharing requests, peers whose digital data sharing requests have been rejected in the past, etc.).

In some embodiments, the provider incentive is used to determine whether a provider peer 130 is likely to reject a request from the requester peer 120. In some embodiments, the provider peer incentive can be determined from the history of previous data transfers and transactions among the provider peer 120 and requester peer 130 devices. For example, if many requests are fulfilled by a provider peer 130 without any reciprocation by the requester peer 120, the probability of rejection of a request increases, and the provider peer 130 has a low provider incentive for accepting requests initiated by the requester peer 120. In some embodiments, the provider incentive can be influenced by the relationship between the devices. For example, if both the provider peer 130 and the requester peer 120 belong to the same user (devices belonging to the same user), it is unlikely for the provider peer to reject a request for data, and, as such, that provider peer 130 is assigned a higher provider incentive.

In some embodiments, the file sharing manager 140 of the requester peer 120 can consider the statistical and/or historical information in determining the number of individual portions of the digital content that it wishes to request from its provider peer devices 130. For example, in one embodiment, the desired file can be available by a number of provider peer devices 120, each of which has at least a portion or a complete copy of the file. The file sharing manager 140 can use the statistical/historical information to make decisions regarding how to obtain the file (e.g., if the file should be obtained as a whole from one peer 130 or in portions from various peers 130, how many portions of the file should be requested, and which portion/portions should be requested from each peer device 130).

Once the provider peer devices 130 are selected, the peer selector 150 forwards a list indicating the selected set of provider peer devices 130 to the file sharing manager 140 of the requester peer device 120. The file sharing manager 140 of the requester peer device 120 attempts to establish a connection to each provider peer device 130 included in the list. In some embodiments, a direct connection can be established to the peer. In the event that a direct connection cannot be established, the server 102 can be used as a relay station to provide indirect communication between the requester and provider peer devices 120, 130. Upon establishing a connection, the requester peer device 120 proceeds to request at least a portion of the digital content from the provider peer device 130.

As noted, in some embodiments, the requester device 120 may have already obtained information identifying the portions of the desired digital content stored at each provider peer device 130 and use the obtained information to determine the specific portions of the file that it 120 wishes to obtain from each provider peer 130. In such embodiments, the requester peer device 120 only requests, from a provider peer device 130, the specific portions that it wishes to obtain from that provider peer device 130.

In some embodiments, the requester peer device 120 may not have any information regarding which specific portions of the file are stored at the provider peer devices 130 and only have identifying information for the provider peer devices 130 that are known to have obtained the file (or portions of the file) at some point in the past. In such embodiments, the file sharing manager 140 of the requester peer 120 initially prompts the provider peer devices 130 to determine if they have any portions of the desired digital file and if they are willing to share their portions of the digital file with the requester peer device 120.

In certain embodiments, the file sharing manager 140 of the requester peer device 120 can utilize a Content Provisioning Table that maps each portion of a file to the provider peers storing the content of that portion and/or to the error correction data belonging to the same block as that portion of the file. The Content Provisioning Table is constructed by making a request to the server 102 for a list of peers 130 storing all or parts of a file and also by making a request to each peer 130 for a report of which file portions are maintained by the peer 130, for example in a cache location 230 (shown in FIG. 2) of the peer device 130.

The file sharing managers 140 of the provider peer devices 130 handle the requests upon reception at the provider peer device 130. In some embodiments, the file sharing manager 140 of the provider peer device 130 can consult its database 160 to determine if it has any portions of the file and also make decisions regarding whether the provider peer device 130 wishes to share the requested digital content with the requester peer device 120.

In some embodiments, the file sharing manager 140 of the provider peer device 130 can further consults its database 160 to obtain statistical and/or historical information regarding the requester peer 120. As noted above, the statistical and/or historical information includes information regarding factors such as whether past digital content requests initiated by the provider peer device 130 and targeting the requester peer device 120 were fulfilled, denied, or dropped.

In some embodiments, the file sharing manager 140 of the provider peer device 130 can consult the state of the provider peer device 140, as well as a set of user preferences, to determine whether it can fulfill a digital content request. Various factors and user preferences can be consulted. For example, the file sharing manager 140 of the provider peer device 130 can consider factors including whether the network resources of the provider peer device 130 are in use by another application, whether the monthly allowances of data transfer for the provider peer device 130 has been exceeded, and whether the provider device is attempting to conserve battery power or processing resources. Other factors, such as statistical and/or historical information can also be considered to describe the current state of the device and to decide whether to fulfill or reject the request. In some embodiments, the state of the provider peer device 140 and the user preferences can further be considered in computing a maximum upload rate.

In the event the provider peer device 130, after consulting its database 160, decides to accept the request initiated by the requester peer device 120, information regarding the available portions of the desired digital data along with information indicating the approval of the file share by the provider peer device 130 is forwarded to the requester peer device 120. In certain embodiments, in the event the provider peer device 130 agrees to share an available portion of the desired digital content with the requester peer device 120, the requested portion is forwarded to the requester peer device 120. In some embodiments, this requested portion can be forwarded using a direct transfer between devices, where the provider peer device 130 loads the desired digital content from its database 160, formats it for network transmission, (e.g., according to a protocol, such as a user datagram protocol), and sends it to the requester peer device 120 via its network connection. In the event the provider peer device 130 decides to deny the request initiated by the requester peer device 120, information indicating the denial of the file share is forwarded to the requester peer device 120.

The file manager 140 of the requester peer device 120 receives the information indicating approval or denial of a file share, as well as information indicating the digital file portions maintained by each provider peer 130 who has approved of the file sharing. This information is forwarded to the peer selector 150 to select a subset of the provider peers 130, from among the provider peers 130 who have approved of the file sharing. In determining the selected subset of the provider peers 130, the peer selector 150 can take into account both the information indicating the specific portions of the file stored at the provider peers 130 who have approved of the file sharing and statistical/historical data obtained from the database 160. This information can also be used identify the specific portions of the digital content that should be obtained from each provider peer 130 in the selected subset of the provider peers. The file manager 140 follows by forwarding requests, to each peer 130, requesting to download the digital content portions that the requester peer 120 wishes to obtain from that provider peer 130.

In some embodiments, the file manager 140 of the requester peer 120 can further consult the database 140 to make a prediction regarding blocks of digital content data that are expected to be lost or damaged during transmission to the requester peer 120. The file manager 140 can access the database 160 and utilize the historical and statistical information regarding the selected subset of provider peers 130 to make predictions as to the certainty according to which it can expect a certain block of digital content data to be received from a given peer device 130.

Based on the predictions made by the file sharing manager 140, the file manager 140 submits a request to the server 102 for a predetermined amount of error correction data that can be used in recovering and reconstructing the digital content. The amount of error correction data depends on the number of blocks of data that the file manager 140 of the peer requester device 120 predicts can be received corrupt or can be lost in transfer. In some embodiments, the error correction data can include Reed-Solomon error correcting codes.

The file sharing manager 140 of the requester peer 120 awaits the arrival of the digital data portions for a predetermined amount of time. This amount of time usually depends on the amount of time that the user is expected to spend to view a current block 192 of the digital content 191. For example, if the user is expected to spend n seconds on viewing the first block of data, the file sharing manager 140 of the requester peer 120 is given n seconds to obtain and request the next block of data. Once the predetermined amount of time has lapsed, the requester peer 120 employs the received portions of the digital content along with the error correction data, if needed, to reconstruct the digital content. Specifically, once the predetermined period of time has lapsed, the requester peer device 120 evaluates the received blocks of data to determine whether all requested blocks have been received. If all requested blocks have been received, the requester peer device 120 uses the received portions of the data to reconstruct the desired digital content. However, if at least one of the requested portions of the digital content has not been received, the requester peer 120 employs the error correcting data acquired from the server 102 to reconstruct the digital content.

FIG. 2 is an example illustration of digital electronic circuitry 200 or computer hardware that can be used with the embodiments disclosed herein. Without limitation, the techniques described herein can be implemented in digital electronic circuitry or in computer hardware that executes firmware, software, or combinations thereof, for example. The implementation can be as a computer program product, e.g., a computer program tangibly embodied in a machine-readable storage device, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

The digital electronic circuitry 200 can include a main memory unit 205 coupled to a processor 240. In some embodiments, the main memory unit 205 can be coupled with a cache unit 230, which is responsible for storing copies of the data from the most frequently used main memory 205 locations. The processor 240 can be connected to various interfaces via an input/output (I/O) device interface 260. Processors 240 suitable for the execution of a computer program include, by way of example, both general and special purpose microprocessors, and any one or more processors of any kind of digital computer. Generally, a processor 240 will receive instructions and data from the main memory 205 (e.g., a read-only memory or a random access memory or both). The essential elements of a computer are the processor 240 for executing instructions and one or more memory devices (e.g., main memory 205) for storing instructions and data.

The memory unit 205 can hold various computer executable instructions and data structures including computer executable instructions and data structures that implement aspects of the techniques described herein. The memory unit 205 can also include an operating system 210 and be arranged to implement various conventional operating system functions including task and process scheduling, memory management, and controlled access to various devices, such as a data storage unit 280. The processes may include computer-executable instructions and data that are configured to implement various aspects of the techniques described herein.

Machine-readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

Generally, the digital electronic circuitry 200 can also include, or be operatively coupled to receive data from or transfer data to, or both, one or more mass storage devices for the storing data 280, e.g., magnetic, magneto-optical disks, or optical disks. Data transmission and instructions can also occur over a communication network. Connection to the communication network can be provided using a network interface 250 coupled to the processor 240.

FIG. 3 is a flow diagram of procedures for viewing a digital content by a requester peer device according to embodiments disclosed herein. As shown in FIG. 3, a user of a requester peer device can select a digital content file from an interface provided by a file sharing manager provided by the peer device (block 310). The selection of the digital content file can be done in a number of ways. For example, the user can select the digital content file from menu outlining the digital content files available by peer devices. In some embodiments, the user can be provided with a search interface such that he/she can use one or more keywords for conducting a search of available digital content. In some embodiments, the selection of digital content file can occur by a requester peer device user's acceptance that a shared content is made available to him/her by a provider peer in the network.

In some embodiments, the requester peer device may include a platform for viewing file content. For example, depending on the type of the file that is being shared, the digital content can be rendered for presentation to the user.

In some embodiments, the requester peer can use a metadata file to facilitate obtaining and viewing of the requested digital content. The metadata file can be stored in a database included in the requester peer device and loaded as needed (block 315). The metadata file can contain information about the requested file that can be used to facilitate obtaining and viewing of the digital content.

In some embodiments, the metadata is created at the time the requested digital content file is created and is updated as the digital file content is changed. For example, in some embodiments, the metadata file for a shared content can be created and stored in the database of the requester peer device, when the requester peer device is invited by a provider peer device to view a shared digital content. The metadata file can be updated as the requester peer device obtains and downloads various blocks and portions of the shared digital content.

In certain embodiments, the metadata file can include a unique key identifying the file within the application, information about the format of the digital file, a content access model describing the most common access patterns to the digital content based on historical information about the user, a value indicating the latest revision of the file, certain data which can facilitate presenting a preview of the file to the user (e.g., a thumbnail for a photo), and a record tracking the caching status of the file on a peer device. In some embodiments, the metadata can store the point where the user left off viewing the data for use in restoration of the data for future viewing. In some embodiments, a copy of the metadata file can be distributed to all peer devices that may be interested in the file upon file related events (e.g., creation, modification, deletion of the file).

As noted previously, the requester peer obtains, from the server, a listing of the provider peer devices that have attempted to obtain a digital file and/or are known to have at least a portion of the digital content. In some embodiments, the requester device can further obtain, from the server, a listing of provider peer devices that maintain reconstruction data (e.g., error correcting data) that may be used for reconstructing the desired digital content. The requester peer device can employ this information to build a Content Provisioning Table (CPT) that contains, for each block of a desired file, a list of provider peers that can provide the requester peer with that specific block of the desired file and/or error correcting data needed to reconstruct that block of the desired file (block 320).

In some embodiments, the user can select whether or not he/she wishes to start viewing a digital content (e.g., video stream) at a certain point within the file and begin to preview the digital content starting at that point (block 321). For example, the user can select to start viewing the file at a point at which they left off the file during the last time he/she viewed it (block 323). In some embodiments, the user can configure a preference within the application indicating where content viewing should begin when a file is selected. If the user does not wish to start previewing the file starting from a point within the file, content preview starts at the beginning of the file (block 325).

In some embodiments, the digital content is not presented to the user until all requested portions of a given block of the content file are obtained and cached locally. In come embodiments, the current block of the digital content is always the block of the digital content that is loaded and presented to the user (block 330). Specifically, the first block that a user selects for viewing is loaded and presented to the user (block 340). For example, if viewing a baseball game and a block having the top of the 8^{th} inning is selected, the portions of the next block of the data (possibly the block having the bottom of the 8^{th} inning) are requested from the peers, cached, reconstructed to create the block, and presented to the user once the viewing of the previous block has ended (block 341).

In some embodiments, even if another block of the digital file is in the progress of loading, the user can interrupt this process by selecting a different block for viewing (block 355). For example, if the user is viewing the block of data having the top of the 8^{th} inning in a baseball game, and the block having the bottom of the 8^{th} inning is being cached, the user can interrupt this process by selecting a different block (e.g., a homerun in the bottom of the 9^{th} inning) for viewing. This newly selected block is set as the current block for loading and presenting to the user of the requester peer device (block 360)

In some embodiments, as the user is viewing a block of data that has already been loaded, a content access model can be utilized to determine the block that should be loaded next for presentation to the user (block 343). The content access model is configured to determine the block of data that will most likely next be presented to the user based on a statistical analysis of the historical usage patterns of the file content and based on the blocks of data that have been already viewed by the user or are being currently viewed by the user. Specifically, in some embodiments, the content access model assigns certain probability levels to each block of data to indicate the probability that the block of data would be the next block that is selected by the user for viewing. The probability levels assigned to the data blocks are compared against a predetermined threshold (block 345) and if the probability assigned to a block exceeds the predetermined threshold, that block is chosen for loading (block 330). In some embodiments, this threshold can be ignored if the file size is below a predetermined threshold, indicating that the cost of caching the entire file is small enough that the benefits of guaranteeing block availability outweigh the cost of loading blocks that are potentially never viewed. If more than one block exceeds the threshold, then the block with the highest probability is chosen for loading.

If the probability for the block does not exceed the threshold (block 350), the block is determined not to be sufficiently likely to be viewed by the user and is not loaded to prevent spurious caching and the resulting network traffic. The threshold can vary on a device-to-device and file-to-file basis. The threshold range can vary from zero to one. A threshold of zero indicates situations in which the portion of the digital content should always be loaded because of the likelihood that it will be viewed. A threshold of one indicates situations where the digital content is not loaded until explicitly loaded by the user. In some embodiments, this threshold may be determined based on the cost of data transfer for a device. For example, in a device with a very restrictive monthly bandwidth cap, unnecessary data transfer is extremely costly and hence the threshold should be very close to one in order to prevent loading of blocks that will not be viewed by the user. In some embodiments, this threshold can be determined based on the type of digital content. For example, the penalty of late arrival of a block for a video stream to the user experience can be considered to be higher than for a block of a word document. Hence, the threshold may be set much closer to zero for a video clip as compared to a word document.

FIG. 4 is a block diagram of procedures for loading a block of data according to an example embodiment disclosed herein. Once a digital content file is selected for requesting from the peers, the requester peer can load the content provisioning table for the file (block 410). The content provisioning table includes identifying information for provider peers that are available for requesting a block of the digital content file. The requester peer maintains a peer performance model for each of its peers and loads the peer performance models of the provider peers included in the content provisioning table (block 415).

In loading a block of data, the requester peer device attempts to achieve at least 100% coverage for that block within an allotted block of time (block 420). Specifically, for a block of digital content with n portions, the sum of distinct data portions and recovery portions (error correcting data) that are successfully received or are already locally available (cached) needs to be greater than or equal to n before the allotted block of time expires. This can serve as the primary terminating condition for loading a block of data. Accordingly, as soon as 100% block coverage is achieved and verified (block 420), the peer requester device determines whether reconstruction of the digital content is necessary (reconstruction is deemed necessary in every case where the entire block of data was not already locally available, i.e., when any portion of the digital content was obtained from a provider peer 130). If reconstruction is deemed necessary (423), the digital content is reconstructed (block 433) and the block loading is considered complete (block 439).

If data is still needed for the achieving local block coverage of at least 100%, the required data is loaded, as necessary, from the network. This can be achieved by making requests to the providing peers and the server, according to a number of factors.

In some embodiments, the requests to the providing peers and the server are submitted according to a block provision profile (BPP). The BPP includes a set of values, defined across the set of unloaded portions of the digital content, which describes, for each portion, the probability that it will be successfully received within the previously referenced allotted block of time. In some embodiments, the BPP is regularly updated as data arrives for the block (block 421).

In certain embodiments, the BPP can be calculated using the peer performance model (PPM). The PPM is defined on a peer by peer basis such that it can be utilized to determine, for each peer, the probability that the peer can successfully provide the portion of digital content within a given amount of time. This probability is termed the provisioning probability and can be calculated based on statistical record of previous interactions with the providing peers. For example, if an application is attempting to load a 100 kB block of digital content from a peer within 5 seconds and that peer has historically demonstrated very low transfer rates (e.g., 10 kB/s), the probability of that peer being able to provide the data in time is considered to be very low. Similarly, if the peer has historically had a high transfer rates (e.g., 100 kB/s), the probability of that peer being able to provide that data in time is considered to be high. These probability values are maintained by the BPP such that if a portion is requested from a peer with a successful arrival probability of x, the value assigned to that portion in the BPP is related to x. In some embodiments, the value assigned to a portion of the digital content in the BPP is equal to the sum of the provisioning probability x and the amount of requested reconstruction data that is allocated for that portion. For example, if the requesting peer 120 concludes, from the PPM, that there is a 70% likelihood that it will receive a portion of digital content, and it has requested one piece of reconstruction data, about 35% of that piece of reconstruction data can be allocated to this portion of digital content, giving it a value in the BPP of 1.05 and leaving 65% of the piece of the reconstruction data allocatable for another portion of digital content.

In some embodiments, a request for data portions is considered to be complete when the BPP value for every portion of digital content exceeds a predetermined threshold. This threshold balances the tradeoff between the confidence that a block will arrive and the probability that unnecessary data will be downloaded.

In some embodiments, the provider incentive can be used as a currency used by the system to prevent greed. In some embodiments, greed can be defined as the refusal by a provider peer 130 to fulfill a request in an effort to prevent sharing of its resources. This can be damaging to the efficacy of the system, as a whole, and may be discouraged in some embodiments through using the incentive-based system described herein. Since provider peer devices with very low provider incentives are likely to deny a new request, such peer devices are removed during the qualifying process. If no qualified provider peer devices exist to provide the requester peer device with a certain portion of the desired digital content, that portion of the digital content is marked as unrequestable and is fulfilled with error correcting data. However, if qualified provider peer devices 130 exist, the portion of digital content is marked as requestable and the peer with the highest provisioning probability is selected for digital data request.

FIG. 5 is a graphical representation of a BPP according to an embodiment disclosed herein. In this example, the digital content is split into 9 portions, of which portions 0, 1, 4, 5, 7, and 9 are already available on the local device and, therefore, are not included in the BPP. Portions 2 and 8 appear to be arriving from relatively reliable providing peers, since the provisioning probabilities for these portions, depicted on the y-axis of this chart, are relatively high. Portion 6 appears to be arriving from a relatively unreliable providing peer, since the provisioning probability of these portions is relatively low. The BPP can be used to determine the amount of reconstruction (error correcting) data needed to reconstruct the digital content at the requester peer. Therefore, sufficient requests, including requests for digital data content portions and requests for reconstruction data are made into the network to meet the threshold for each value of the BPP, and no new requests need to be made in the current iteration. As data arrives, the BPP is constantly updated and more requests can be made if the network status causes the BPP value of a digital content data portion to fall below the threshold. For example, the BPP value of a digital content data portion can fall below the threshold if a peer fails to respond to a request within an allowable timeframe or if the peer transmits data at a much slower rate than expected.

The BPP can be used to determine the amount of reconstruction (error correcting) data needed to reconstruct the digital content at the requester peer. Therefore, sufficient requests, including requests for digital data content portions and requests for reconstruction data are made into the network to meet the threshold for each value of the BPP, and no new requests need to be made in the current iteration. As data arrives, the BPP is constantly updated and more requests can be made if the network status causes the BPP value of a digital content data portion to fall below the threshold. For example, the BPP value of a digital content data portion can fall below the threshold if a peer fails to respond to a request within an allowable timeframe or if the peer transmits data at a much slower rate than expected.

In some embodiments, the number of reconstruction portions can be determined by finding the ceiling of the sum of the differences between the BPP value of each portion and the BPP threshold. For example, assuming a threshold of 1.05 for digital data portions shown in FIG. 5, the number of reconstruction portions that need to be requested can be computed as:

Ceiling(Σ{Δ₂,Δ₃,Δ₆,Δ₈})=Ceiling({1.05−0.9}+{1.05 −0.7 }+{1.05 −0.4}+{1.05−0.99})=Ceiling(1.21)=2

Therefore, a total of 2 reconstruction (error correcting) data portions are requested.

Requests for error correcting data can be cancelled in the event that data is no longer needed. For example, if a sufficient amount of requested digital data portions arrives quickly enough, such that only a subset of the requested error correcting data is required for reconstruction, the requester peer device can cancel its request for the error correcting portions that are no longer required (e.g., in the example presented above, after all of the portions are received, the request for the second portion can be cancelled, if that portion is no longer required).

Peer assessment and digital data requests are repeated, over time, until the block coverage exceeds 100%. In some embodiments, as time progresses, the requester peer self-regulates towards urgency. Specifically, as the block time expires, the peer performance model returns an acceptable provisioning probability for the very best and fastest peers and tends towards requesting more reconstruction data from the server, which is assumed by the system to be the most reliable data provider.

While the invention has been particularly shown and described with reference to specific illustrative embodiments, it should be understood that various changes in form and detail may be made without departing from the spirit and scope of the invention.

1. A computerized method comprising: at a requester communication peer device, disposed in a multi-node communication network having a plurality of communication peer devices managed by a server:
obtaining information identifying one or more provider communication peer devices storing at least one portion of a select digital content;
for each of the one or more identified provider communication peer devices, determining statistical information including a likelihood that a request, initiated by the requester communication peer device, for providing an individual portion of the digital content is accepted and successfully fulfilled, the likelihood being determined by considering historical occurrences of acceptance, denial, suspension, and successful digital content transfers between the requester and the provider communication device;
for each individual portion of the digital content, selecting a provider communication peer device yielding highest likelihood of acceptance and successful fulfillment from among the identified one or more provider communication peer devices;
requesting each individual portion of the digital content from its corresponding selected provider communication peer device; and
reconstructing the digital content from the individual portions received from the selected provider communication peer devices.

2. The method of claim 1 further comprising requesting an amount of reconstruction data associated with the requested portions of the digital content from the server, the amount of requested reconstruction data being dependent on the statistical information.

3. The method of claim 2 further comprising:
determining whether the individual portions of digital content are received within a predetermined time window; and
in an event at least one portion of the digital content is not received within the predetermined time window, reconstructing the digital content using a combination of individual portions received from the selected provider communication peer devices and the reconstruction data received from the server.

4. The method of claim 2 further comprising:
determining whether the individual portions of digital content are received within a predetermined time window; and
in an event all portions of the digital content is received within the predetermined time window, reconstructing the digital content solely based on the individual portions received from the selected provider communication peer devices.

5. The method of claim 1 further comprising at the requester communication peer device:
selecting the select digital content through a user interface provided by the requester peer device; and
receiving information identifying the selected provider communication peer devices from the server, each provider communication peer device storing at least one individual portion of the requested digital content.

6. The method of claim 1 further including determining, at the requester communication peer device, a number of individual portions of digital content to request from each of the provider communication peer devices based on the statistical information.

7. The method of claim 1 wherein the statistical information further includes historical data transfer rates between the requester communication peer device and each selected provider communication peer device.

8. The method of claim 1 wherein the statistical information further includes historical information relating to at least one of time to first byte arrival, data integrity, routability, or a combination thereof in previous data transfers between the requester and the provider communication device.

9. (canceled)

10. The method of claim 1 further including determining an order for requesting the individual portions of digital content from each of the selected provider communication peer devices based on statistical information representing historical access patterns of the digital content.

11. The method of claim 1 wherein selecting the provider communication peer devices further includes communicating with each of the provider communication peer devices and determining which of the individual portions of the select digital content is stored at each selected provider device.

12. A computer program product, tangibly embodied in a non-transitory computer readable storage medium, comprising instructions being operable to cause a data processing system to: at a requester communication peer device, disposed in a multi-node communication network having a plurality of communication peer devices managed by a server:
obtain information identifying one or more provider communication peer devices storing at least one portion of a select digital content;
for each of the one or more identified provider communication peer devices, determine statistical information including a likelihood that a request, initiated by the requester communication peer device, for providing an individual portion of the digital content is accepted and successfully fulfilled, the likelihood being determined by considering historical occurrences of acceptance, denial, suspension, and successful digital content transfers between the requester and the provider communication device;
for each individual portion of the digital content, select a provider communication peer device yielding highest likelihood of acceptance and successful fulfillment from among the identified one or more provider communication peer devices;
request each individual portion of the digital content from its corresponding selected provider communication peer device; and
reconstruct the digital content from the individual portions received from the selected provider communication peer devices.

13. The computer program product of claim 12, further comprising instructions being operable to cause the data processing system to: request an amount of reconstruction data associated with the requested portions of the digital content from the server, the amount of requested reconstruction data being dependent on the statistical information.

14. The computer program product of claim 13, further comprising instructions being operable to cause the data processing system to:
determine whether the individual portions of digital content are received within a predetermined time window; and
in an event at least one portion of the digital content is not received within the predetermined time window, reconstruct the digital content using a combination of individual portions received from the selected provider communication peer devices and the reconstruction data received from the server.

15. The computer program product of claim 13, further comprising instructions being operable to cause the data processing system to:
determine whether the individual portions of digital content are received within a predetermined time window; and
in an event all portions of the digital content are received within the predetermined time window, reconstruct the digital content solely based on the individual portions received from the selected provider communication peer devices.

16. The computer program product of claim 12, further comprising instructions being operable to cause the data processing system to: at the requester communication peer device:
select the select digital content through a user interface provided by the requester peer device; and
receive information identifying the selected provider communication peer devices from the server, each provider communication peer device storing at least one individual portion of the requested digital content.

17. The computer program product of claim 12, further comprising instructions being operable to cause the data processing system to: determine, at the requester communication peer device, a number of individual portions of digital content to request from each of the provider communication peer devices based on the statistical information.

18. The computer program product of claim 12 wherein the statistical information further includes historical data transfer rates between the requester communication peer device and each selected provider communication peer device.

19. The computer program product of claim 12 wherein the statistical information further includes historical information relating to at least one of time to first byte arrival, data integrity, routability, or a combination thereof in previous data transfers between the requester and the provider communication device.

20. (canceled)

21. The computer program product of claim 12, further comprising instructions being operable to cause the data processing system to: determine an order for requesting the individual portions of digital content from each of the communication peer devices based on statistical information representing historical access patterns of the digital content.

22. The computer program product of claim 12, further comprising instructions being operable to cause the data processing system to: select the communication peer devices further includes communicating with each of the provider communication peer devices and determine which of the individual portions of the select digital content is stored at each selected provider device.
